(19) United States
(12) Patent Application Publication
(10) Pub. No.: US 2016/0102470 A1
(43) Pub. Date: Apr. 14, 2016

(54) Seamless Pool Liner and Method of Making the Same

(71) Applicants: Harold Albert Brooks, Clifton Park, NY (US); Ronal Peter Crowley, JR., Stillwater, NY (US); Mathew Thomas Geyman, Fort Wayne, IN (US); Corey Joseph Akstull, Malta, NY (US)

(72) Inventors: Harold Albert Brooks, Clifton Park, NY (US); Ronal Peter Crowley, JR., Stillwater, NY (US); Mathew Thomas Geyman, Fort Wayne, IN (US); Corey Joseph Akstull, Malta, NY (US)

(21) Appl. No.: 14/512,521

(22) Filed: Oct. 13, 2014

(51) Int. Cl. E04H 4/14; B32B 37/06; B32B 37/10

(52) U.S. Cl. CPC E04H 4/14; B32B 37/10; B32B 37/06; E04H 2004/146

(57) ABSTRACT

A method of making a pool liner, said pool liner having a floor section, a wall section and substantially invisible seams, said method comprising the steps of: providing a plurality of floor sheets wherein each sheet of said plurality of floor sheets has an edge; arranging said floor sheets in a pre-determined direction such that at least one edge of one sheet of said first plurality of floor sheets overlaps an adjacent edge of one sheet of said first plurality of floor sheets thereby creating a floor sheet to floor sheet intersection; heat welding said overlapping floor sheets at said floor sheet to floor sheet intersection; providing at least one wall sheet where said at least one wall sheet has an edge; placing said at least one wall sheet generally perpendicularly relative to said plurality of floor sheets; overlapping said at least one wall sheet with said floor sheets thereby creating a floor sheet to wall sheet intersection; and heat welding said at least one wall sheet with overlapping floor sheets at said floor to wall intersection.

### BACKGROUND

1. Field of the Art

The present invention relates generally to fluid reservoir liners and methods of making the same. More specifically, the present invention relates to pool liners and methods of making the same.

2. Description of the Prior Art

Most fluid reservoir liners comprise multiple sheets joined together to produce a water impermeable barrier. Materials for these sheets typically include polyurethane, polyvinylchloride, polypropylene, or polyethylene, and the sheets can either be glued or welded together. However, gluing can be very labor intensive and often uses volatile solvents that are employed during the gluing operation. Thus, welding is the preferred method of joining multiple sheets, and there are three main methods of welding in use: radio frequency (“RF”) welding, ultrasonic welding, and heat welding. Heat welding includes hot wedge welding, hot air welding, and impulse welding.

The RF method is probably the most widely used approach for heat sealing. The RF welder is basically an antenna (the die) that is poorly matched to the amplifier, thereby producing a great deal of heat rather than radio waves between the antenna and the underlying plate. In practice, the two fabric pieces are laid on the plate. Typical RF welding dies used in pool liner manufacturing are about 3 to 4 feet in length and approximately 0.75 inch wide. The die is then brought down, thereby pressing the two pieces together. The operator then initiates the welding process by pressing a pair of push buttons. The actual RF process takes from about 5 to 15 seconds, depending upon the thickness of the pattern pieces and the amount of RF energy available from the machine.

There are, however, disadvantages to the RF method. RF welding is a slow process because the size of the die is limited by the available energy of the unit. Additionally, due to the die and plate arrangement, the RF method is typically limited to seams or joints that can be laid flat for welding. Three dimensional dies and plates are occasionally used, but these devices are quite expensive, and they require a vacuum or other device to hold the fabric in position as the die is applied.

Ultrasonic welding is a process that is like RF welding, with the exception of the energy source. Rather than using radio waves, ultrasonic welding uses sound waves that basically vibrate the plastic molecules until sufficient heat is generated to melt the coatings.

In the wedge method of heat welding, two fabric pieces are drawn across a hot iron (or wedge) and then are pressed together. A heated wedge is precisely positioned at the weld point providing the required heat. The fabric or film is then pulled across the heated wedge. The tightly temperature of the wedge can range from 700 F to 920 F (400 C to 490 C). Hot wedge welders typically experience a hot section immediately after the beginning of the weld as the wedge accumulates excess heat when idle. Another disadvantage is that, since the heat energy must pass through a solid object to reach the seam, the maximum speed of the hot wedge welding process is limited by the thermal conductivity of the wedge.

Hot air heat sealing is another welding process used to join thermoplastic industrial fabrics and films using very precise heat, speed and pressure settings. The correct combination of these three parameters allows one to achieve a complete weld. In the case of hot air welding, heat is provided by compressed air blowing across electrical heat elements and is injected at the welding point. The temperature can range from 1000 F to 1,350 F (400 C to 750 C). In general, hot air welding is much faster than other methods; it can accommodate three dimensional patterns, and it requires no dies or tooling. In a hot air welder, the flow of hot air that floods the seam is not subject to contamination, as with the wedge welder, and there is no initial drop off of heat at the beginning of the seam.

In impulse welding, layers of thermoplastic sheets are heated and fused to form a welded seam by clamping them together in close contact with a shielded electric heating element. Often, a thin nichrome wire is positioned behind a coating or film. During the heating cycle an electric current is passed along the wire, resulting in rapid heating. At the conclusion of the heating cycle, the current is switched off and the wire cools rapidly due to its low thermal mass. The sheets being joined remain under pressure for the duration of the cooling cycle. In this way, the parts being welded experience a well-controlled heating and cooling regime, while still being held under pressure. However, because of the long cycle times necessary for impulse welding and other technical limitations, it is not known or used in the field of fluid reservoir liner manufacturing.

Unfortunately, the known sealing methods, as they are used in the prior art for fluid reservoir liners, generally produce a highly visible seam that is aesthetically unsuitable for many applications, including, for example, pool liners. Several examples of these known methods are discussed below.

U.S. Pat. Nos. 4,379,114 and 4,568,588 disclose a method of joining narrow waterproof sheets to obtain a waterproof sheet of wide width having a gently curved joint which is free from any acutely stepped portion. It comprises cure tape between the overlapping edge portions of the sheets to be joined, positioning a piece of cushiony material below or above the overlapping edge portions, and heating the overlapping edge portions and the cure tape under pressure. The cure tape has a width which is substantially equal to that of the overlapping edge portions before pressure is applied thereto. When pressure is applied, the cure tape projects in opposite directions beyond the extremities of the overlapping edge portions. One form of the joint thus formed is flat on one surface and gently curved on the other surface, while another form is gently curved on both surfaces thereof.

U.S. Pat. No. 4,737,213 discloses a method for heat sealing a portion of an upper heat sealable thermoplastic membrane to a portion of a lower heat sealable thermoplastic membrane which comprises placing a detachable stabilizer strip on the outer surface of the upper membrane over the over-lap seam portions to be sealed. The stabilizer strip must fully adhere or have mechanical contact to retain the dimensional stability of the upper membrane while maintaining the relative positions of the membranes. A hot air medium is directed between the upper and lower membranes thereby affecting a heat seal there between. Once the overlapped and sealed portions of the membranes are permitted to cool, the stabilizer strip may be removed.

U.S. Pat. No. 4,855,004 discloses an automatic seam welder for thermoplastic material includes a single piece frame riding on two drive wheels and a caster, the drive wheels being driven by a drive motor through a helical spring clutch. A heat gun is gimbal mounted to the frame and includes a blower, heating element, and shaped foot to direct hot air between overlapped thermoplastic sheets. A thermocouple in the foot directly senses the air temperature and, through a control circuit in a control instrument enclosure, is used to control power to the heater element. A guide wheel, foot rest and air dam are also provided.

U.S. Pat. No. 4,910,059 discloses roof membranes for providing improved lap joints with adjacent roof membranes, wherein opposed edges of the adjacent membranes for the lap joint are tapered.

U.S. Pat. No. 5,234,533 discloses a portable hot sheet welder used for making reservoir liners and covers. The welder is sued to fuse together overlapped edges of lengthy sheets of synthetic rubber material or the like. The welder has a front carriage and a rear carriage both of which have a weight box for removably receiving cast ingot weights. The front carriage has a pair of laterally spaced main drive compression wheels for pressing the overlapped sheets together after they have had their surfaces heated to a sufficiently high temperature by a hot air shoe pounded on the front carriage. A pair of laterally spaced secondary compression wheels is supported from the front end of the rear carriage. An eccentric mechanism attached to the rear carriage provides structure for pivoting the main drive compression wheels upwardly from their pressure producing position.

U.S. Pat. No. 5,416,932 discloses an above-ground outdoor circular swimming pool having the typical outer circumscribing support walls with a through-space as symbolic porthole-like window there is placed within space circumscribed by the outer circumscribing support walls, a water-retaining translucent or transparent liner mounted at and suspended circumscribingly from upper securing structure at the top of the circumscribing support walls. Thereby the secured and suspended transparent liner wall when containing water is pressed toward the porthole-like window, such that there is provided a line-of-sight view from each of the inside and the outside through the transparent liner. The liner itself if sufficiently rigid or sturdy in part or in whole, and/or alternatively a separate supporting transparent sheet-like transparent rigid and sturdy solid and/or mesh structure overlaps the through-space.

U.S. Pat. No. 5,624,511 discloses an apparatus and a method for welding overlapping edge sections of heat sealable materials are disclosed. The apparatus generally includes a frame, a heating body attached to the frame for being positioned between the overlapping sheets to heat the sheets, an alignment control mechanism for urging the overlapping sheet into a desired alignment relative to the overlapped sheet and a pressure roller for pressing the heated sections together to weld them together.

U.S. Pat. No. 5,695,586 discloses a method of securing elongated lengths of lighting track in the aggregate coping face of a liner type swimming pool. The method includes applying double sided adhesive tape to a shelf face of a form board utilized to define the cross-sectional contour of coping to be poured. The track is removably mounted adhesively against the tape and retained thereat until after curing of the aggregate has been completed. Following curing of the aggregate, the form board is removed to expose the face of the track in the face of the coping.

U.S. Pat. No. 5,713,164 discloses the installation of a vinyl liner within an in-ground swimming pool is carried out using a direct drive, over-hung vacuum machine to exhaust air from between the liner and the steel walls and cement bowl within which the liner is installed. The vacuum machine has the overhung impellor located within a volute chamber isolated from the driving electric motor, so that the induced air flow is segregated from the driving motor. The vacuum machine impellor is of non-corrosive material, to avoid corrosion of the impellor when water is entrained, and to avoid the consequent imbalance and undue wear of the bearing that would otherwise ensue. The paddle-style impellor blades ensure that the vacuum suction is insufficient to cause intake of the pool liner into the air-evacuation hose.

U.S. Pat. No. 5,802,631 discloses a method for installing a liner in a swimming pool including a wall having a liner edge retainer extending along the upper periphery. With the pool containing water, an edge of a liner is attached to the retainer at a first position on the wall and a pulling device is attached to the liner edge at a position opposite the retainer attachment. The pulling device is manipulated to drag the liner along the pool bottom and up the wall to a position opposite the first position where the edge is then attached to the retainer. A substantial portion of the pool water is scooped up in the liner and the remaining water can be pumped from between the wall and liner. The method can be used to install a second liner over an existing first liner by using different liner edge retainers. More than one embodiment of the pulling device is disclosed.

U.S. Pat. No. 5,903,933 discloses a method of securing elongated lengths of lighting track in the aggregate coping face of a liner type swimming pool. The method includes applying double sided adhesive tape to a shelf face of a form board utilized to define the cross-sectional contour of coping to be poured. The track is removably mounted adhesively against the tape and retained thereat until after curing of the aggregate has been completed. Following curing of the aggregate, the form board is removed to expose the face of the track in the face of the coping.

U.S. Pat. No. 6,471,803 discloses a hot air welding apparatus that provides a computer control system and two high torque stepper motors, one for each drive wheel. The computer control system allows the speed and position of the drive wheels to be regulated with a very high accuracy. The computer control system allows the drive wheel settings to be adjusted while the seam is being welded and further includes an automatic ramp capability, a repeat mode, and a test strip mode. Further, the computer control system is capable of controlling the temperature of the air used in the welding process. The present invention further provides methods of joining pieces of fabric, films and extruded materials without using traditional sewing techniques and further provides products seamed by such methods.

U.S. Pat. No. 7,866,360 discloses a hot air welding nozzle for a hot air welding device for welding overlapping webs of sealing material. The hot air welding nozzle includes a connection for a hot air supply, a top and a bottom heat plate forming an air space, and at least one rear outlet between the top and bottom heat plate on a facing side that is oriented in a direction opposite to the moving direction of the hot air welding device, with at least one front outlet relative to the moving direction of the hot air welding device, and with air guides that extend beyond the facing sides of the heat plates, at least on the inner side.

U.S. patent application publication no. 20100263748 discloses first and second recycled geosynthetic sheets having overlapping portions. A heat welded splice is formed along the overlapping portions creates a fluid seal between the first and second recycled geosynthetic sheets so that the first and second geosynthetic sheets collectively function as a fluid liner.

U.S. patent application publication no. 20110219601 discloses a seaming machine and method are provided for seaming segments of sheet material to one another to form larger sheets. The machine typically includes a frame with a pair of spaced seaming devices mounted thereon for respectively seaming opposed edges of the segments of sheet material to one another. The process allows for the seaming of multiple sheet segments while the sheet segments remain atop a work surface. Relative back and forth movement between various components and the work surface typically facilitate the process.

Thus, the known prior art does not disclose a pool liner in which all of the seams are substantially invisible. Thus, a need exists for such a pool liner and a method of making the same.

### SUMMARY

In one exemplary embodiment, the present invention provides a pool liner having substantially invisible seams, said pool liner comprising: at least two flexible thermoplastic panels, said panels comprising at least one set of overlapping heat welded edges which form a substantially invisible seam relative to a seam produced by radio frequency welding.

In another exemplary embodiment, the present invention provides a method of making a pool liner having substantially invisible floor seams, said method comprising the steps of: providing a plurality of floor sheets wherein each sheet of said plurality of floor sheets has an edge; arranging said floor sheets in a pre-determined direction such that at least one edge of one sheet of said first plurality of floor sheets overlaps an adjacent edge of one sheet of said first plurality of floor sheets thereby creating a floor sheet to floor sheet intersection; and heat welding said overlapping floor sheets at said floor sheet to floor sheet intersection.

In another exemplary embodiment, the present invention provides a method of making a pool liner having substantially invisible seams, a floor section and a wall section, said method comprising the steps of: providing a plurality of floor sheets wherein each sheet of said plurality of floor sheets has an edge; arranging said floor sheets in a pre-determined direction such that at least one edge of one sheet of said first plurality of floor sheets overlaps an adjacent edge of one sheet of said first plurality of floor sheets thereby creating a floor sheet to floor sheet intersection; heat welding said overlapping floor sheets at said floor sheet to floor sheet intersection; providing a wall sheet, said wall sheet having an edge; overlapping said wall sheet edge with said floor sheet edges thereby creating a floor sheet to wall sheet intersection; and heat welding said wall sheet with said floor sheets at said floor to wall intersection.

In another exemplary embodiment, the present invention provides a method of making a pool liner having substantially invisible seams, a floor section and a wall section, said method comprising the steps of: providing a plurality of floor sheets wherein each sheet of said plurality of floor sheets has an edge; arranging said floor sheets such that at least one edge of one sheet of said first plurality of floor sheets overlaps an adjacent edge of one sheet of said first plurality of floor sheets thereby creating a floor sheet to floor sheet intersection; heat welding said overlapping floor sheets at said floor sheet to floor sheet intersection; providing a plurality of wall sheet wherein said plurality wall sheet has an edge; arranging said wall sheets such that at least one edge of said wall sheet abuts an adjacent edge of one sheet of said plurality of wall sheets thereby creating a wall sheet to wall sheet intersection; providing a reinforcement strip against said wall sheet to wall sheet intersection; impulse welding wall sheets and reinforcement strip at said wall sheet to wall sheet intersection; overlapping said wall sheet with said floor sheet thereby creating a floor sheet to wall sheet intersection; and impulse heat welding said wall sheet with floor sheets at said floor to wall intersection.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only.

In the drawings:

FIG. 1 shows a common swimming pool having a prior art pool liner.

FIG. 2 shows a prior art side elevation view of overlapping sheets for making a pool liner.

FIG. 3 shows a prior art side elevation view of overlapping sheets bonded using a radio frequency weld.

FIG. 4A shows a prior art top perspective view of overlapping sheets bonded using a radio frequency weld.

FIG. 4B shows a close up view of FIG. 4A.

FIG. 5 shows a block diagram of the steps of making a pool liner according a method of the present invention.

FIG. 6 shows an exemplary diagrammatic view of an impulse welding device for use with the present invention.

FIG. 7 shows an exemplary embodiment hot air welding device for use with the present invention.

FIG. 8 shows a second exemplary embodiment of a hot air welding device for use with the present invention.

FIG. 9 shows an exemplary embodiment of a hot wedge welding device for use with the present invention.

FIG. 10A shows a prior art view of overlapped panels for a pool liner.

FIG. 10B shows directionally overlapped panels for a pool liner.

FIG. 11 shows a functional diagram impulse welding device for use with the present invention.

FIG. 12 shows a side elevation view of overlapping sheets bonded using a method of the present invention to produce an invisible seam.

FIG. 13A shows a top perspective view of overlapping sheets bonded using the method of FIG. 12.

FIG. 13B shows a close up view of FIG. 13A.

FIG. 14 shows a side elevation view of overlapping sheets for making a pool liner having substantially invisible seams in accordance with another method of the present invention.

FIG. 15 shows a side elevation new of overlapping sheets bonded using the method of FIG. 14.

FIG. 16 shows a common swimming pool having a pool liner constructed in accordance with the present invention.

### DETAILED DESCRIPTION OF THE EMBODIMENTS

The present invention will be discussed hereinafter in detail in terms of the preferred embodiment according to the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscuring of the present invention.

This detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations.

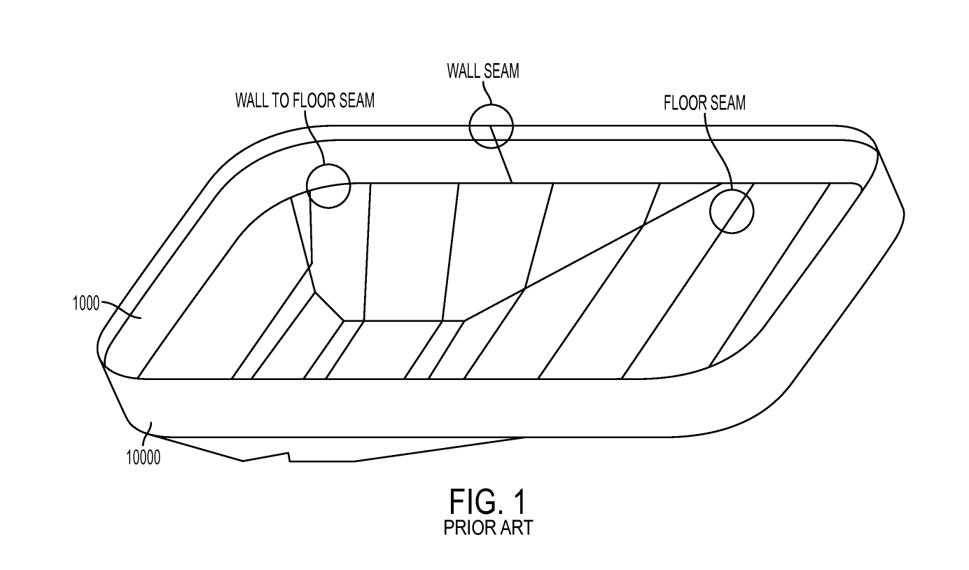

All of the implementations described below are exemplary implementations provided to enable persons skilled in the art to make or use the embodiments of the disclosure and are not intended to limit the scope of the disclosure, which is defined by the claims. In the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring first to FIG. 1, there is shown a swimming pool 10000 having a prior art pool liner 1000. As shown in FIG. 1, prior art pool liner 1000 generally comprises a floor section and a wall section. Prior art pool liner 1000 is then disposed and adhered to the floor and wall by known prior art methods generally known in the art of pool installation.

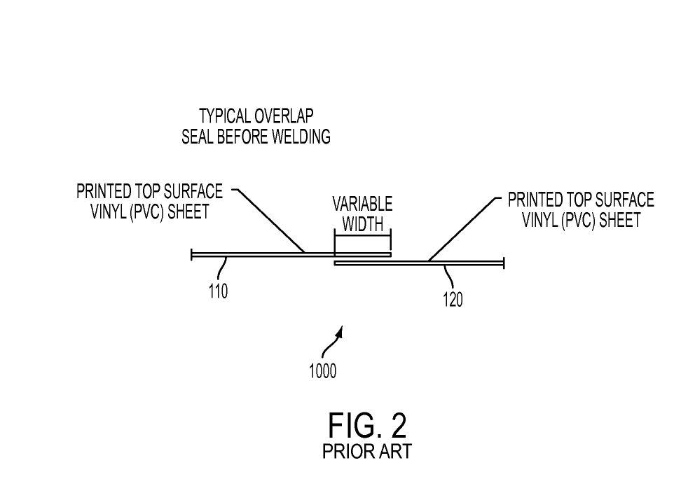

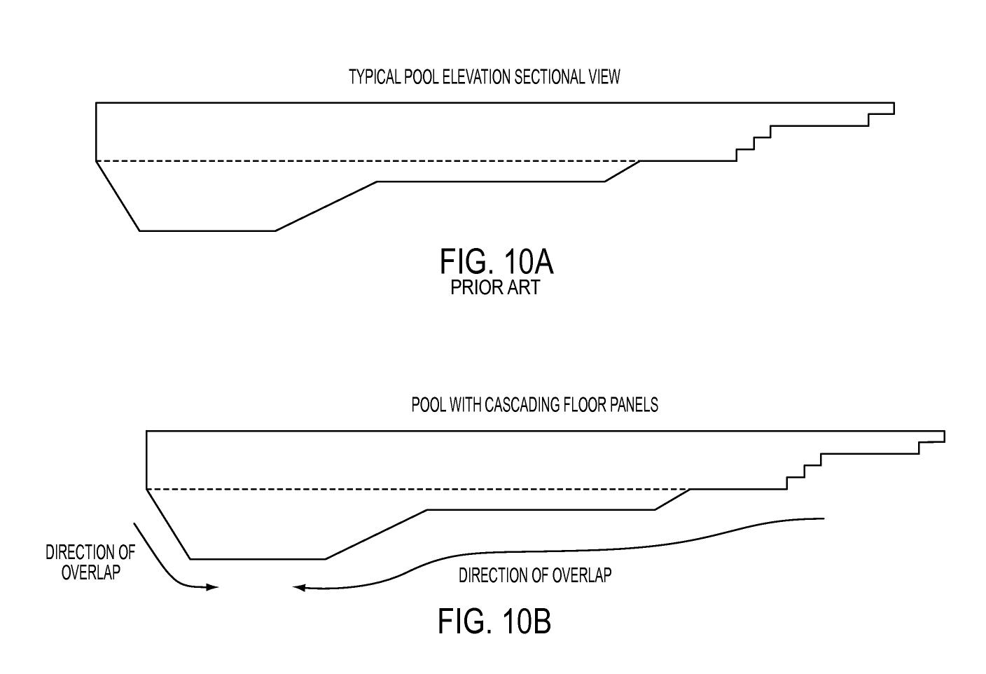

Referring next to FIG. 2, there is shown a prior art side elevation view of overlapping sheets for making a water reservoir liner such as pool liner 1000. Pool liner 1000 comprises a plurality of sheets 110 and 120 joined together at seams to produce a water impermeable barrier along the floor and wall of a pool or other fluid reservoir. The sheets are generally comprised of polyvinylchloride, and the sheets can either be glued or welded. However, other materials may be used such as polyurethane, polypropylene, or other thermoplastics. Most commonly, as illustrated in FIG. 10a, prior art pool liners generally comprise sheets arranged without regard to direction, and the sheets are joined together using common Radio Frequency (“RF”) welding techniques.

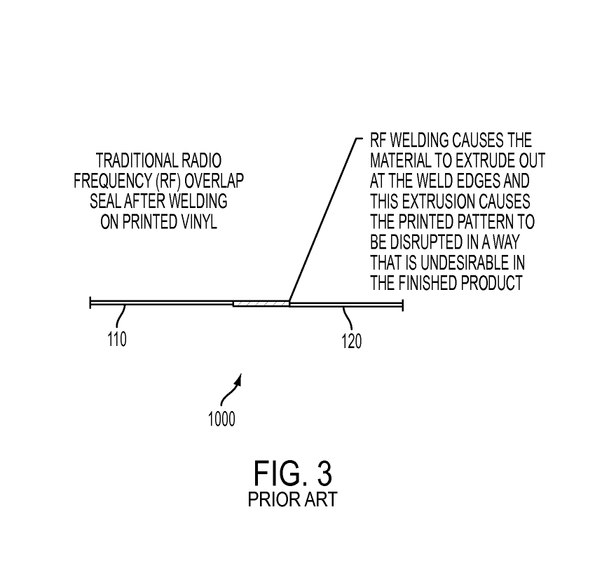

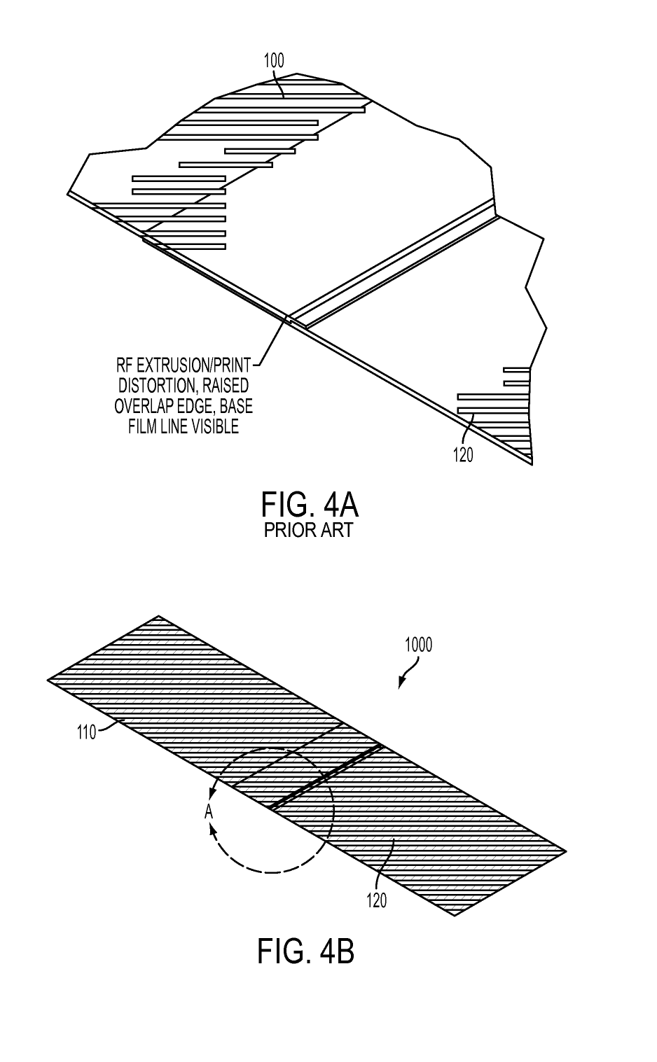

Referring next to FIG. 3, there is shown a prior art side elevation view of overlapping sheets 110 and 120 bonded using RF welding. During the welding process, sheets 110 and 120 are overlapped and pressed together using a flat bar having radiused edges to create a single piece. Unfortunately, RF welding causes the material to extrude at the weld edges. This extrusion disrupts any printed pattern on the sheets and leaves the finished product with an undesirable visible line at the seam as shown in FIG. 4.

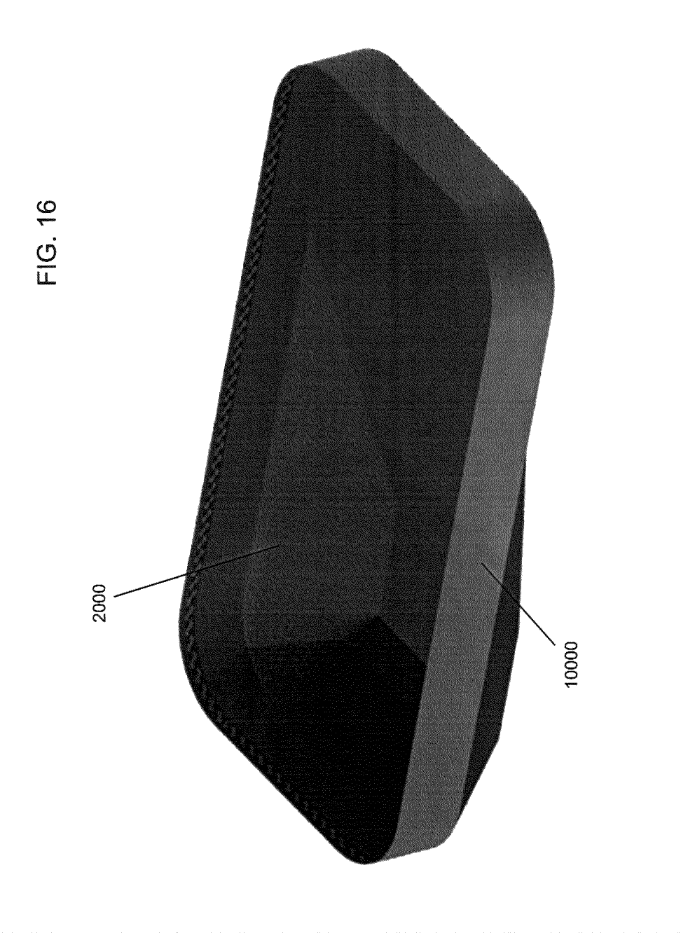

The highly visible seams of prior art pool liners are heavily disfavored by pool owners, but the methods of the present invention result in a liner having substantially invisible seams. Pool liner 2000, manufactured according to the method of the present invention and illustrated in FIG. 16 is much more desirable. As shown in FIG. 16, pool liner 2000 comprises a floor section and a wall section, and it is disposed and adhered to the floor and wall of pool 10000.

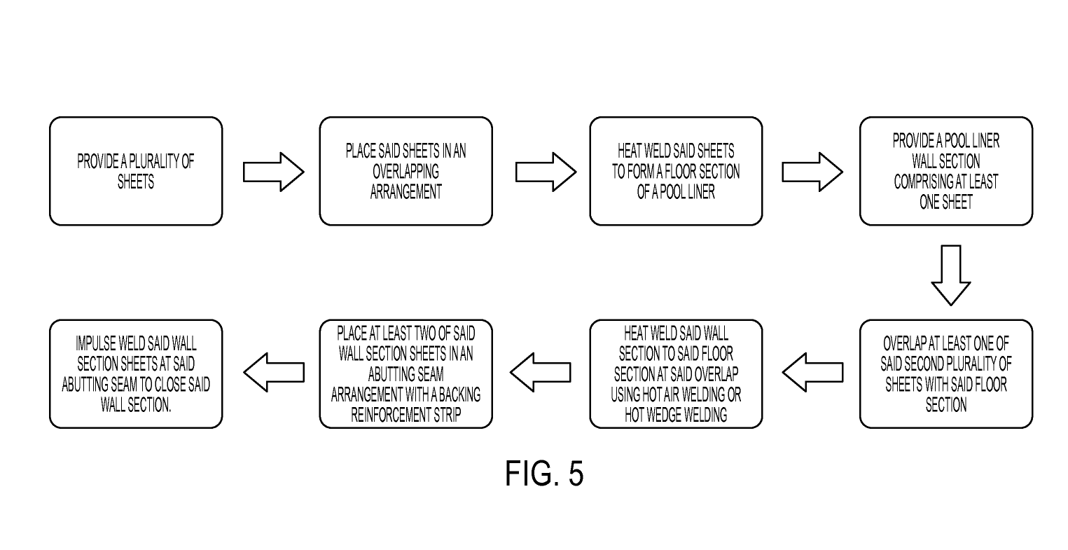

Referring now to FIG. 5, there is a shown a functional block diagram that illustrates the steps of an exemplary embodiment of a method of making a pool liner 2000 according to the present invention. The method of the present invention generally comprises forming pool liner 2000 by a method comprising the steps of: providing a plurality of floor sheets; placing said sheets in an overlapping arrangement; heat welding said floor sheets at said overlapping intersection to form a floor section with substantially invisible seams; providing a wall section; overlapping said wall section with said floor section; heat welding said wall section to said floor section at said overlap; and closing said wall section by abutting two sheets reinforcing said abutting sheets at said abutting intersection and impulse welding said sheets at said abutting intersection.

As illustrated in FIG. 5, a method of making a pool liner according to the present invention comprises providing a plurality of floor sheets. The sheets may be of any desired size or shape, but preferably the sheets have a generally square or rectangular surface area with generally straight edges. The sheets preferably comprise thermoplastic materials selected from a group comprising polyurethane, polyvinylchloride, polypropylene, and polyethylene.

As further illustrated in FIG. 5, the present method of making a pool liner having generally invisible seams further comprises arranging the plurality of sheets such that at least one edge of one sheet overlaps an adjacent edge of another sheet thereby creating a floor sheet to floor sheet intersection. Preferably, the sheets are arranged in a cascading manner in a predetermined direction such that the seams are oriented downwardly to be less visible from the top. Seams that point down, as shown in FIG. 10b, collect less dirt and debris as a result of any crevice being substantially on the underside of the seam.

Referring still to FIG. 5, the method of the present invention further comprises heat welding said overlapping the floor sheets at said floor sheet to floor sheet intersection. Hot air heat welding is a plastic welding technique that uses a specially designed heat gun that produces a jet of hot air that softens the pieces to be welded prior to pressing the two pieces together which creates a seam. The seam is substantially invisible, but it is as strong as a seam created using prior art methods.

The typical hot air welding apparatus injects a stream of hot air from a hot air nozzle between two sheets of plastic. The temperature of the hot air can be set in the range of approximately 500 to 1350 degrees F. The plastic pieces are then pinched between and pulled through the apparatus between a two drive wheels or between a drive wheel and a flat member. The distance from the hot air nozzle and the pinch point between the drive wheels or between the drive wheel and flat surface is in the range of approximately 0.25 to 0.75 inch. The wheel speed determines how long the plastic is exposed to the hot air stream before it passes between the wheel and flat surfaces. With a constant air temperature, the amount of heat energy delivered to the fabric is inversely proportional to the wheel speed; a faster speed decreases the exposure and vice versa.

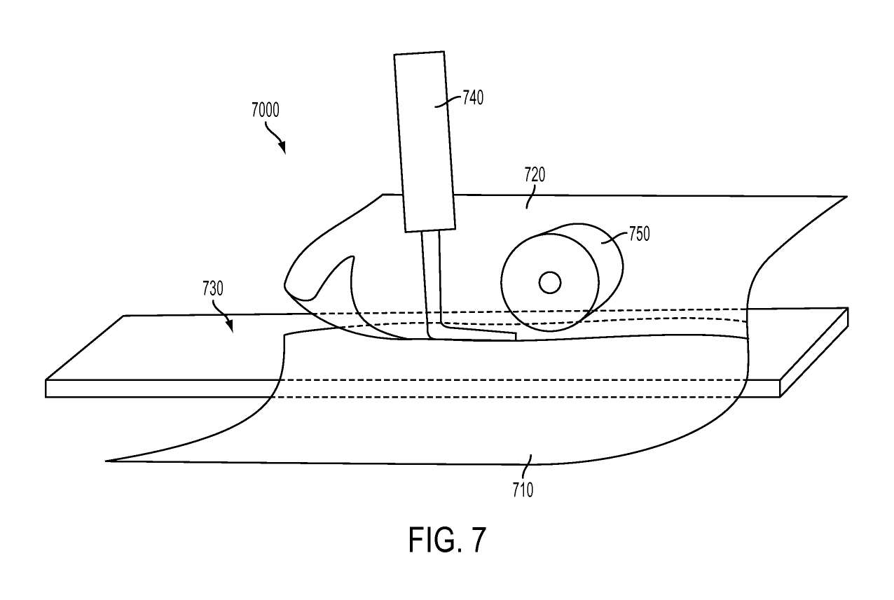

As illustrated in FIG. 7, and exemplary hot air welding device 7000 according to the present invention generally comprises a mechanical housing or chassis (not shown) having a hard vacuum surface 730 used to secure bottom plastic sheet 710 flatly to surface 730. As further illustrated in FIG. 7, welding device 7000 further comprises hot air nozzle 740 which is used to focus a stream of hot air at the overlapping portion of sheets 710 and 720 to form a plastic weld between sheets 710 and 720 as the same are fed and mechanically pressed together between pressure wheel 750 and vacuum surface 730.

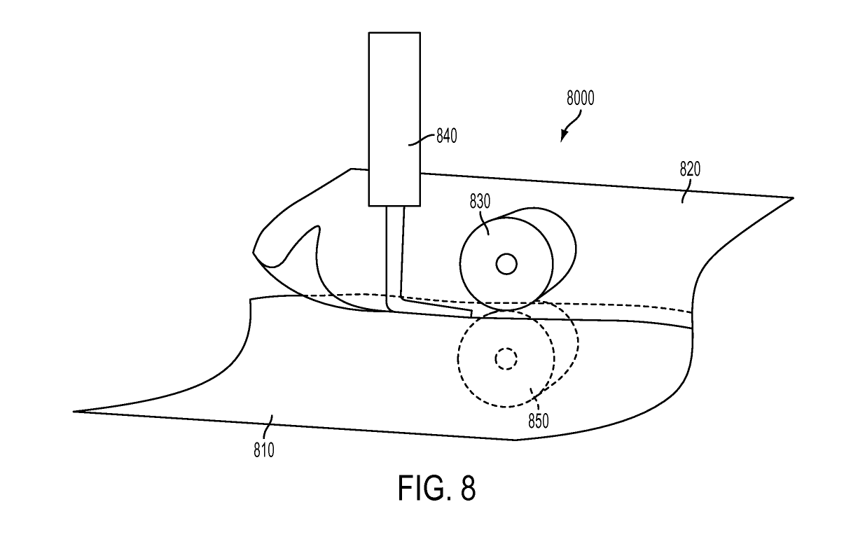

Referring now to FIG. 8, there is shown an alternative exemplary hot air welding device 8000 according to the present invention. Hot air welding device 8000 comprises a mechanical housing or chassis (not shown) having two relatively close wheels 830 and 850. At least one of the wheels 830 and 850 is further connected to a drive means (not shown). As further illustrated in FIG. 8, welding device 8000 further comprises hot air nozzle 840 which is used to focus a stream of hot air at the overlapping portion of sheets 810 and 820 as the same are fed and mechanically pressed between wheel 850 and wheel 830. The temperature of the hot air can be set in the range of approximately 1000 to 1350 degrees F.

The distance from the hot air nozzle and the pinch point between the two wheels is in the range of approximately 0.25 to 0.75 inch. The wheel speed determines how long the plastic is exposed to the hot air stream before it passes between the wheels. With a constant air temperature, the amount of heat energy delivered to the fabric is inversely proportional to the wheel speed; a faster speed decreases the exposure and vice versa.

As further illustrated in FIG. 5, the method of the present invention further comprises bonding a wall portion to the floor portion to manufacture pool liner 2000. The wall portion may comprise one sheet or a plurality of bonded sheets. In either event the wall and floor sections may be hot air welded as described above or hot wedge welded together.

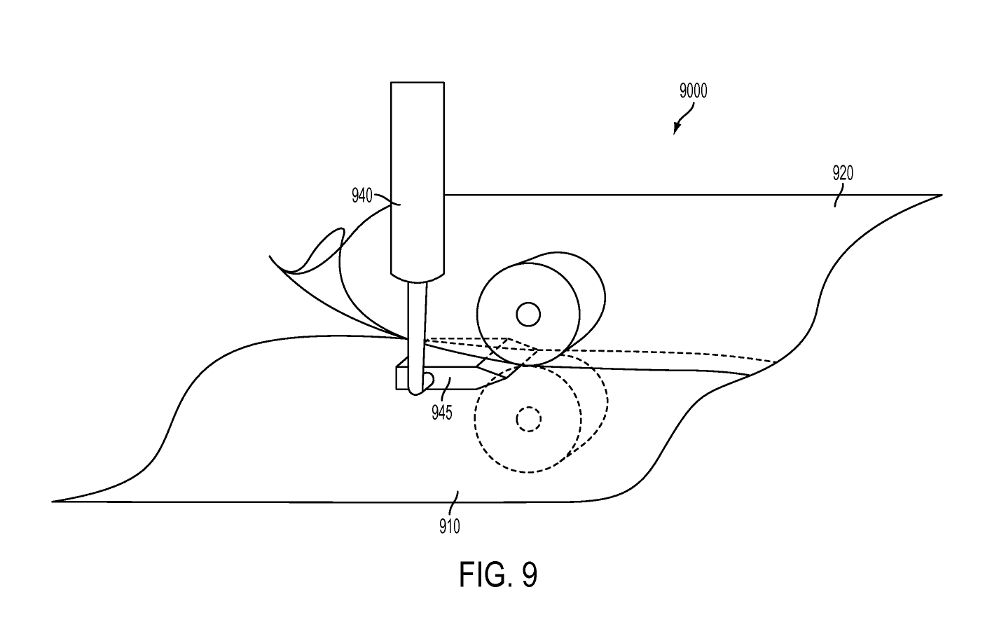

FIG. 9 shows an exemplary hot wedge welding device 1000 for use with the present invention. Hot wedge welding device 9000 comprises a mechanical housing or chassis (not shown) having a hot air nozzle 940. Hot wedge welder 9000 further comprises a pair of wheels 930 and 950, between which overlapping sheets 910 and 920 are fed, as with hot air welding device 8000. However, wedge welding device 9000 further comprises wedge 945 which is heated to a desired temperature for welding sheets 910 and 920 as the same are fed over heated wedge 945.

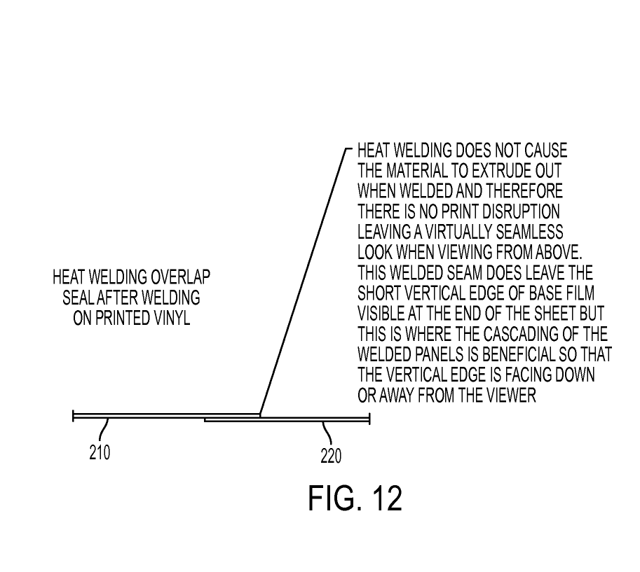

Referring now to FIG. 11, there is shown a side elevation view of overlapping sheets 210 and 220 for constructing the floor to floor or wall to floor seams of making a pool liner 2000 arranged in a manner consistent with the present invention. Pool liner 2000, in accordance with the present invention, comprises a plurality of overlapping plastic sheets arranged and joined together to form a water impermeable sealing layer that is placed on the floor and wall of a swimming pool as shown in FIG. 16. FIG. 12 then shows overlapping sheets 210 and 220 bonded using a method of the present invention to produce a substantially invisible seam.

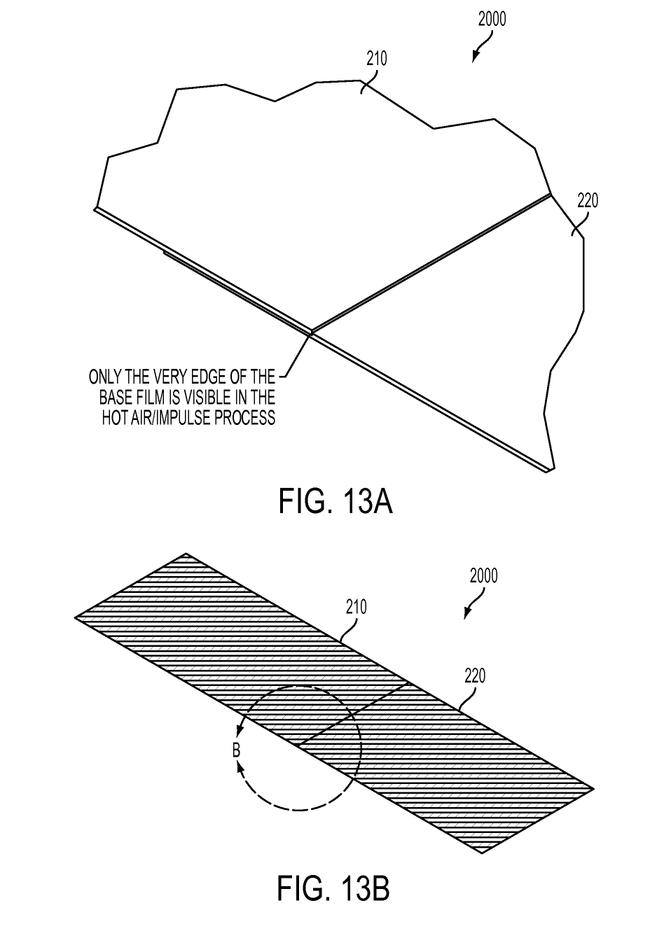

As shown in FIG. 13, sheet 210 and sheet 220 typically include top surfaces comprising a graphic design or printed tile pattern. During the manufacturing process, sheet 210 is placed in an overlapping position relative to sheet 210 with an overlap suitable to create a desired view of the graphic design when sheets 210 and 220 are joined by air welding using machine 7000 or 8000. RF welding causes the material to extrude out at the weld edges, and this extrusion distorts the graphic design on the face of the welded sheets to a degree that is undesirable in the finished product. However, heat welding, as used in the present invention, does not cause the material to extrude out when welded. Thus, there is no image distortion, and there is a virtually invisible seam between sheets. Again, it is preferable to cascade sheets so the edges of the overlap face down, away from the viewer, as shown, for example, in FIG. 10b, where there is shown a top perspective view of overlapping sheets bonded using a method of the present invention to produce an invisible seam.

Returning again to FIG. 5, the method of the present invention further comprises constructing a wall portion for pool liner 2000 by arranging the wall sheets such that at least one edge of the wall sheet abuts an adjacent edge of another sheet of said plurality of wall sheets thereby creating a wall sheet to wall sheet intersection. A reinforcement strip is provided against the back of the wall sheet to wall sheet intersection. Next, the wall sheets and reinforcement strip are impulse welded at said wall sheet to wall sheet intersection. Impulse technology relies on heat, time, and pressure. With an impulse welding machine, pressure is applied to the seam area by two impulse-heating bars. Heat is created by pulsing energy through the heating element in the top and bottom bars for the duration of the weld.

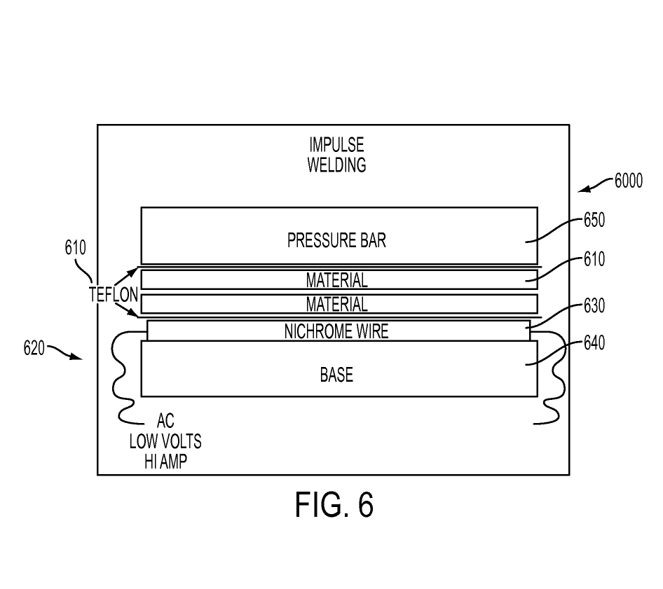

FIG. 6 illustrates an exemplary impulse welding device 6000 for use with the present invention. Impulse welding device 6000 comprises pressure Teflon coated bar 650 and Teflon coated base 640. Base 640 further comprises a nichrome wire 630 heated by a low voltage high amp current. Plastic sheets 610 620 are fed between coated pressure bar 650 and coated base 640 which is heated by wire 630 to a desired temperature.

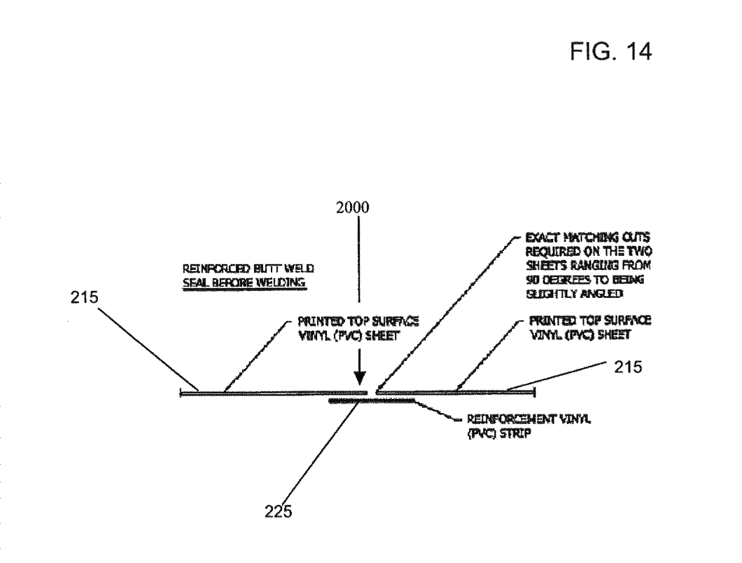

FIG. 14 shows a side elevation view of overlapping sheets to be bonded using the impulse welding method of the present invention to produce a pool liner having a substantially invisible seam. Pool liner 2000 comprises a plurality of abutting wall sheets 215. Alternatively, the wall portion of pool liner 200 may comprise a single wall sheet 215 having and opening or slit to be closed by the method described herein.

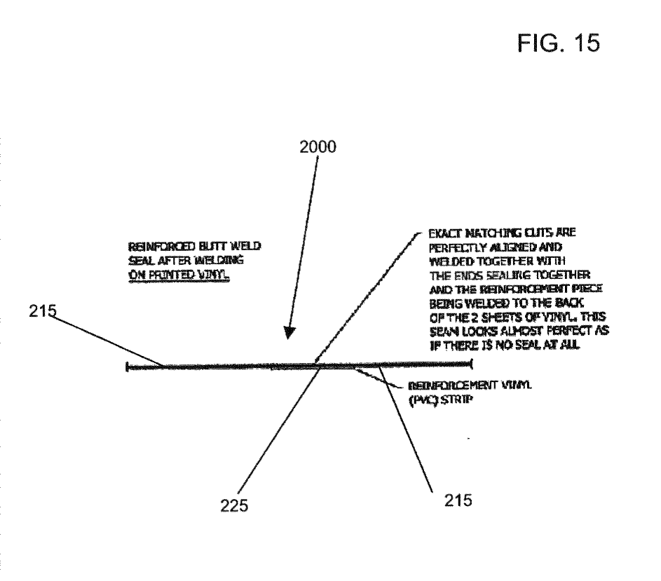

As further illustrated in FIG. 15, the bond between sheets 215 further includes reinforcement layer 225 disposed behind the intersection of abutting sheets 215. Sheets 215 preferably have a square or rectangular surface comprising generally straight edges that are pulled together until the edges abut as shown in FIGS. 14 and 15.

Referring still to FIGS. 14 and 15, nearly exactly complimentary cuts are required for the abutting sheets 210. These cuts may be corresponding 90° cuts or complimentary cuts, such as, corresponding alternative 45° cuts. Prior art RF welding techniques cause the material to extrude out at the weld edges, and this extrusion distorts the graphic design on the face of the welded sheets to a degree that is undesirable in the finished product. However, impulse welding, as it used in the present invention, does not cause the material to extrude out when welded. Thus, there is no image distortion, and there is a virtually invisible seam between sheets. In fact, after the abutting pieces 215 are joined along with reinforcement sheet 225, there is substantially no visible seal, as illustrated in FIG. 13 and FIG. 16.

The above-described embodiments are merely exemplary illustrations set forth for a clear understanding of the principles of the invention. Many variations, combinations, modifications, or equivalents may be substituted for elements thereof without departing from the scope of the invention. It should be understood, therefore, that the above description is of an exemplary embodiment of the invention and included for illustrative purposes only. The description of the exemplary embodiment is not meant to be limiting of the invention. A person of ordinary skill in the field of the invention or the relevant technical art will understand that variations of the invention are included within the scope of the claims.

1. A method of making a pool liner having substantially invisible floor seams, said method comprising the steps of: providing a first plurality of floor sheets wherein each sheet of said plurality of floor sheets has an edge; arranging said floor sheets such that at least one edge of one sheet of said first plurality of floor sheets overlaps an adjacent edge of one sheet of said first plurality of floor sheets thereby creating a floor sheet to floor sheet intersection; and bonding said overlapping floor sheets at said floor sheet to floor sheet intersection.

2. The method of claim 1, wherein the step of bonding said overlapping floor sheets comprises hot wedge welding.

3. The method of claim 1, wherein the step of bonding said overlapping floor sheets comprises hot air welding.

4. The method of claim 1, wherein the step of bonding said overlapping floor sheets comprises impulse welding.

5. The method of claim 1, wherein the floor sheets comprise polyurethane.

6. The method of claim 1, wherein the floor sheets comprise polyvinylchloride.

7. The method of claim 1, wherein the floor sheets comprise polypropylene.

8. The method of claim 1, wherein the floor sheets comprise polyethylene.

9. The method of claim 1, wherein the floor sheets comprise a thermoplastic material.

10. A method of making a pool liner having substantially invisible wall seams, said method comprising the steps of: providing at least two thermoplastic wall sheets wherein each wall sheet has an edge; arranging said wall sheets such that at least one edge of one wall sheet abuts at least one edge of an adjacent wall sheet thereby creating a wall sheet to wall sheet intersection; providing a reinforcement strip against the back of said wall sheet to wall sheet intersection; and bonding said wall sheets and said reinforcement strip at said wall sheet to wall sheet intersection.

11. The method of claim 10, wherein the step of bonding said abutting sheets and said reinforcement strip comprises hot wedge welding.

12. The method of claim 10, wherein the step of bonding said abutting sheets and said reinforcement strip comprises hot wedge welding.

13. The method of claim 10, wherein the step of bonding said abutting sheets and said reinforcement strip comprises impulse welding.

14. The method of claim 10, wherein the wall sheets comprise a thermoplastic material.

15. The method of claim 10, wherein the wall sheets comprise polyurethane.

16. The method of claim 10, wherein the wall sheets comprise polyvinylchloride.

17. The method of claim 10, wherein the wall sheets comprise polypropylene.

18. The method of claim 10, wherein the wall sheets comprise polyethylene.

19. A method of making a pool liner having substantially invisible floor seams and substantially invisible floor to wall seams, said method comprising the steps of: providing a plurality of floor sheets wherein each sheet of said plurality of floor sheets has an edge; arranging said floor sheets such that at least one edge of one sheet of said first plurality of floor sheets overlaps an adjacent edge of one sheet of said first plurality of floor sheets thereby creating a floor sheet to floor sheet intersection; bonding said overlapping floor sheets at said floor sheet to floor sheet intersection; providing at least one wall sheet; overlapping said at least one wall sheet with said floor sheets thereby creating a floor sheet to wall sheet intersection; and bonding said wall sheet with floor sheets at said floor to wall intersection.

20. The method of claim 19, wherein the step of bonding said overlapping sheets comprises hot wedge welding.

21. The method of claim 19, wherein the step of bonding said overlapping sheets comprises hot air welding.

22. The method of claim 19, wherein the step of bonding said overlapping sheets comprises impulse welding.

23. The method of claim 19, wherein the sheets comprise a thermoplastic material.

24. The method of claim 19, wherein the sheets comprise polyurethane.

25. The method of claim 19, wherein the sheets comprise polyvinylchloride.

26. The method of claim 19, wherein the sheets comprise polypropylene.

27. The method of claim 19, wherein the sheets comprise polyethylene.

28. A method of making a pool liner having substantially invisible seams, said method comprising the steps of: providing a plurality of floor sheets wherein each sheet of said plurality of floor sheets has an edge; arranging said floor sheets such that at least one edge of one sheet of said first plurality of floor sheets overlaps an adjacent edge of one sheet of said first plurality of floor sheets thereby creating a floor sheet to floor sheet intersection; bonding said overlapping floor sheets at said floor sheet to floor sheet intersection; providing at least one wall sheet, said wall sheet having at least one opening; overlapping said at least one wall sheet with said floor sheets thereby creating a floor sheet to wall sheet intersection; and bonding said at least one wall sheet with floor sheets at said floor to wall intersection; arranging said at least one wall sheet such that adjacent edges of said opening abut one another thereby creating a wall sheet to wall sheet intersection; providing a reinforcement strip against the back of said wall sheet to wall sheet intersection; and bonding said wall sheets and said reinforcement strip at said wall sheet to wall sheet intersection.

29. The method of claim 28, wherein the step of bonding said overlapping sheets comprises hot wedge welding.

30. The method of claim 28, wherein the step of bonding said overlapping sheets comprises hot air welding.

31. The method of claim 28, wherein the step of bonding said abutting sheets comprises impulse welding.

32. The method of claim 28, wherein the sheets comprise thermoplastic material.

33. The method of claim 28, wherein the sheets comprise polyurethane.

34. The method of claim 28, wherein the sheets comprise polyvinylchloride.

35. The method of claim 28, wherein the sheets comprise polypropylene.

36. The method of claim 28, wherein the sheets comprise polyethylene.

37. The method of claim 28, wherein the step of bonding said overlapping sheets comprises impulse welding.

38. A pool liner having substantially invisible floor seams, said pool liner comprising: at least two flexible thermoplastic sheets, said sheets comprising at least one set of overlapping bonded edges which form a substantially invisible seam relative to a seam produced by radio frequency welding.

39. The pool liner of claim 38, wherein said overlapping edges are bonded by a process selected from the group consisting of hot wedge welding, hot air welding, and impulse welding.

40. The pool liner of claim 38, wherein the sheets comprise a material selected from the group consisting of polyurethane, polyvinylchloride, polypropylene, and polyethylene.

41. A pool liner having substantially invisible wall seams, said pool liner comprising: at least two flexible thermoplastic wall sheets, said wall sheets comprising at least one set of abutting bonded edges having a reinforcement strip which form a substantially invisible wall seam relative to a seam produced by radio frequency welding.

42. The pool liner of claim 41, wherein said abutting edges and reinforcement strip are bonded by a process selected from the group consisting of hot wedge welding, hot air welding, and impulse welding.

43. The pool liner of claim 41, wherein the sheets comprise a material selected from the group consisting of polyurethane, polyvinylchloride, polypropylene, and polyethylene.

44. A pool liner having substantially invisible seams, said pool liner comprising: a floor section comprising at least two flexible thermoplastic floor sheets, said floor sheets comprising at least one set of overlapping bonded edges which form a substantially invisible floor seam relative to a seam produced by radio frequency welding; said pool liner further comprising a wall section comprising at least one flexible thermoplastic wall sheet, said wall sheet comprising at least one set of abutting impulse welded edges which form a substantially invisible wall seam relative to a seam produced by radio frequency welding, wherein said wall section is overlapped with said floor section and bonded thereto to form a substantially invisible seam between said wall section and said floor section.

45. The pool liner of claim 44, wherein said overlapping edges are welded by a process selected from the group consisting of hot wedge welding, hot air welding, and impulse welding.

46. The pool liner of claim 44, wherein the sheets comprise a material selected from the group consisting of polyurethane, polyvinylchloride, polypropylene, and polyethylene.
